(19) United States
(12) Patent Application Publication
(10) Pub. No.: US 2017/0026795 A1
(43) Pub. Date: Jan. 26, 2017

(54) WIRELESS CHARGING DEVICES WITH LOCATION-BASED MESSAGE PROCESSING SYSTEM

(71) Applicant: Che-Min Wu, Torrance, CA (US)

(72) Inventor: Che-Min Wu, Torrance, CA (US)

(21) Appl. No.: 15/219,191

(22) Filed: Jul. 25, 2016

Related U.S. Application Data
(60) Provisional application No. 62/196,526, filed on Jul. 24, 2015.

(51) Int. Cl. H04W 4/02; H04L 29/08; H04W 4/12

(52) U.S. Cl. CPC H04W 4/023; H04W 4/12; H04L 67/12

(57) ABSTRACT

A location-based message processing system may include one or more internet of things (IoT) devices, a cloud processing unit, a message exchanging system (MXS), and one or more mobile terminals, wherein the IoT device is configured to transmitted location-based information to the cloud processing unit, which is configured to save, maintain and analyze the location-based information, and transmit customized information for each user to the MXS, and the MXS is configured to deliver such information to an application software (APP) of the mobile terminal of each user. In one embodiment, the IoT devices in the present invention are wireless charging devices including but not limited to, wireless chargers, charging tables, wearable charging devices, portable/non-portable chargers. In another embodiment, the cloud processing unit may include at least a processor and memory device to process, save and maintain data transmitted from the IoT devices.

### CROSS-REFERENCE TO RELATED APPLICATIONS

This application claims priority under 35 U.S.C. §119 (e) to U.S. Provisional Patent Application Ser. No. 62/196,526, filed on Jul. 24, 2015, the entire contents of which are hereby incorporated by reference.

### FIELD OF THE INVENTION

The present invention generally relates to an architecture of internet of things (IoT) service, and more specifically to a system that includes wireless charging devices, mobile application and cloud-based message exchanging platform, and a method for implementing the system.

### BACKGROUND OF THE INVENTION

Mobile phones are used for a variety of purposes, including keeping in touch with family members, conducting business, and having access to a telephone in the event of an emergency. Some people carry more than one cell phone for different purposes, such as for business and personal use. More recently, smartphones emerged to quickly replace traditional mobile phones. Simply speaking, smartphones are mobile phones equipped with more advanced computing capability and connectivity to perform much more tasks than basic mobile phones. More particularly, smartphones typically combine the features of a mobile phone with some other popular consumer devices, such as a personal digital assistant (PDA), a media player, a digital camera, or a GPS navigation unit. Modern smartphones may include more features including a touchscreen computer, a web browser and a plurality of application software (“Apps”).

One of the most important concerns of smartphone users is the battery life. As stated above, modern smartphones can perform just like a mini computer, however, unlike computers that may be used with the power cords for most of the time, smartphone users usually carry the phones with them and the battery inside the phone may be a sole power source thereof. Therefore, it may be inconvenient for the users if the battery cannot last long enough and the smartphone may lose the portability if the user has to charge it frequently.

To solve the battery issues in smartphones and other mobile devices such as tablets, various kinds of power banks have been developed to help people more conveniently charge the mobile devices. Recently, wireless charging has become and more popular with the main benefit being ease of use.

The Internet of Things (IoT) is based on the idea that everyday objects (including wireless charging devices), not just computers and computer networks, can be readable, recognizable, locatable, addressable, and controllable via an IoT communications network. With the rapid development of IoT technology, the wireless charging devices can be integrated with mobile services to enhance the user experience of wearable and mobile phone devices. So, users can manage their wireless charging devices and use a message exchanging system (MXS) to interact with other devices. Moreover, with the rise of mobile advertisement market, especially the location-based mobile advertisement market, a new opportunity is emerging for traditional shopping malls, hotels, restaurants, coffee shops, etc. to provide wireless charging services via IoT communication network to further expand their revenue and market.

### SUMMARY OF THE INVENTION

It is an object of the present invention to provide an internet of things (IoT) system including wireless charging devices and a location-based message exchanging system (MXS).

It is another object of the present invention to provide an IoT system including wireless charging devices to be integrated with mobile services to enhance the user experience of wearable and mobile phone devices.

It is a further object of the present invention to provide an architecture of IoT services, so the users can manage their wireless charging devices and use the location-based message exchanging system (MXS) to interact with other devices.

It is still a further object of the present invention to generate a location-based mobile advertisement market for traditional shopping malls, hotels, restaurants, coffee shops, etc. to provide wireless charging services via IoT communication network to further expand their revenue and market.

In one aspect, a location-based message processing system may include one or more internet of things (IoT) devices, a cloud processing unit, a message exchanging system (MXS), and one or more mobile terminals. In an exemplary embodiment, the IoT devices in the present invention are wireless charging devices including but not limited to, wireless chargers, charging tables, wearable charging devices, portable/non-portable chargers.

In one embodiment, the cloud processing unit may include at least a processor and memory device to save and maintain data transmitted from the IoT devices, and further analyze the data therefrom through so call “Big Data Processing” to provide better and customized services for the users. The data transmitted from the IoT devices can be, but not limited to the location information of the IoT devices and marketing information including promotions where the IoT devices are located. It is noted that the communication between the IoT devices and the cloud processing unit is WiFi or other viable communication protocol.

In a further embodiment, the message exchanging system (MXS) can be used to receive data from the cloud processing unit, and send out information and instruction to the mobile terminals that may have an application software (“App”) installed therein. The information may include, but not limited to the locations of the IoT devices and promotions at the locations of the IoT devices. The communication between MXS and the App can be achieved by REST (Representational State Transfer) application programming interfaces (“APIs”).

In still a further embodiment, the mobile terminal may be equipped with an App that can be used to receive specific location-based information from MXS, and if the user wishes to receive the information from MXS, he/she can just turn on the App. For example, when the user's cell phone battery level becomes low, he/she can turn on the App, which is configured to receive the information from MXS regarding the locations of the wireless charging devices, the distances thereof, and the promotions at which the wireless charging devices are at.

In another embodiment, the App can be managed by a website, where the user can input and update his/her personal information, and the cloud processing unit can incorporate the user's personal information to generate customized information to the user.

In a further aspect, a method for processing location-based messages may include steps of: one or more IoT devices transmitting at least location and promotion information to a cloud processing unit; the cloud processing unit analyzing the information from the IoT devices and generating customized information for each user; a message exchanging system (MXS) receiving the information generated by the cloud processing unit and sending such information to a mobile terminal of the user; and the user receiving the information sent from MXS through an application software (“App”), said information at least including the IoT's location and promotion at the IoT's location.

In one embodiment, the IoT device can be wireless charging devices including but not limited to, wireless chargers, charging tables, wearable charging devices, portable/non-portable chargers. In another embodiment, the communication between the IoT devices and the cloud processing unit is WiFi or other viable communication protocol. In a further embodiment, the communication between the MXS and the App can be achieved by REST (Representational State Transfer) application programming interfaces (“APIs”). In still a further embodiment, the method for processing messages may further include a step of managing the App through the mobile terminal or a website. In yet a further embodiment, the IoT device can directly communicate with the App of the mobile terminal to display the location and promotion information.

### BRIEF DESCRIPTION OF THE DRAWINGS

FIG. 1 is a schematic view of a location-based message processing system including one or more internet of things (IoT) devices, cloud processing unit, a message exchanging system (MXS) and one or more mobile terminals.

FIG. 2 is a schematic block diagram of the location-based message processing system in the present invention.

FIG. 2a illustrates a schematic block diagram of the location-based message processing system of another aspect in the present invention.

FIG. 3 is a schematic view of the mobile terminal showing the location-based message and promotion information.

FIG. 4 illustrates a method of processing location-based message in the present invention.

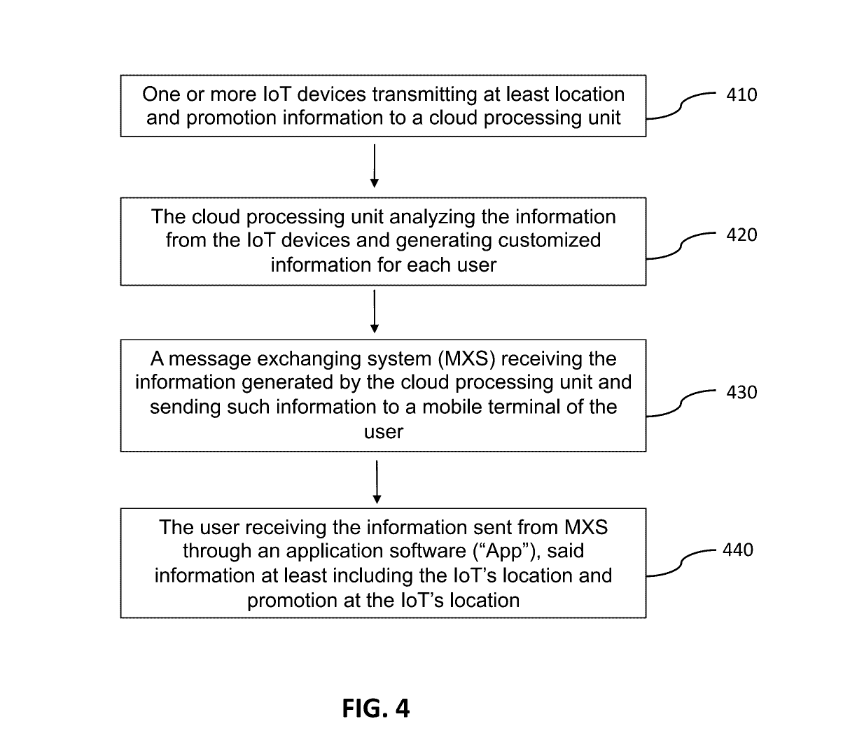

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

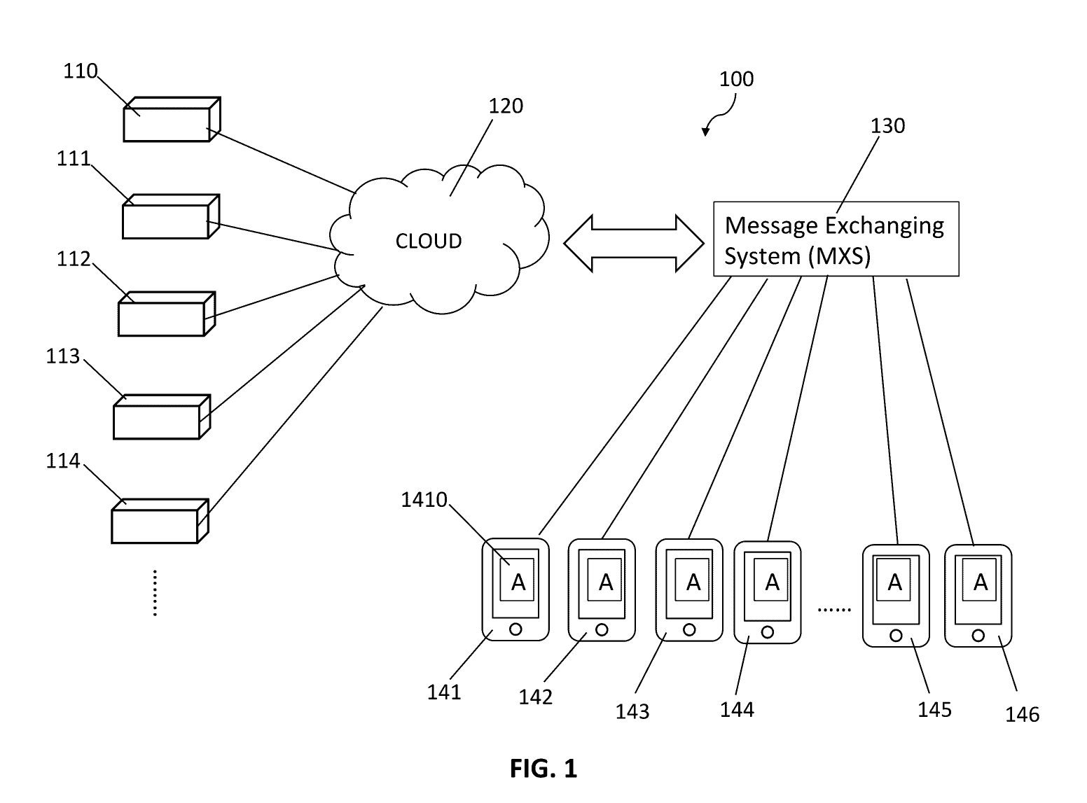

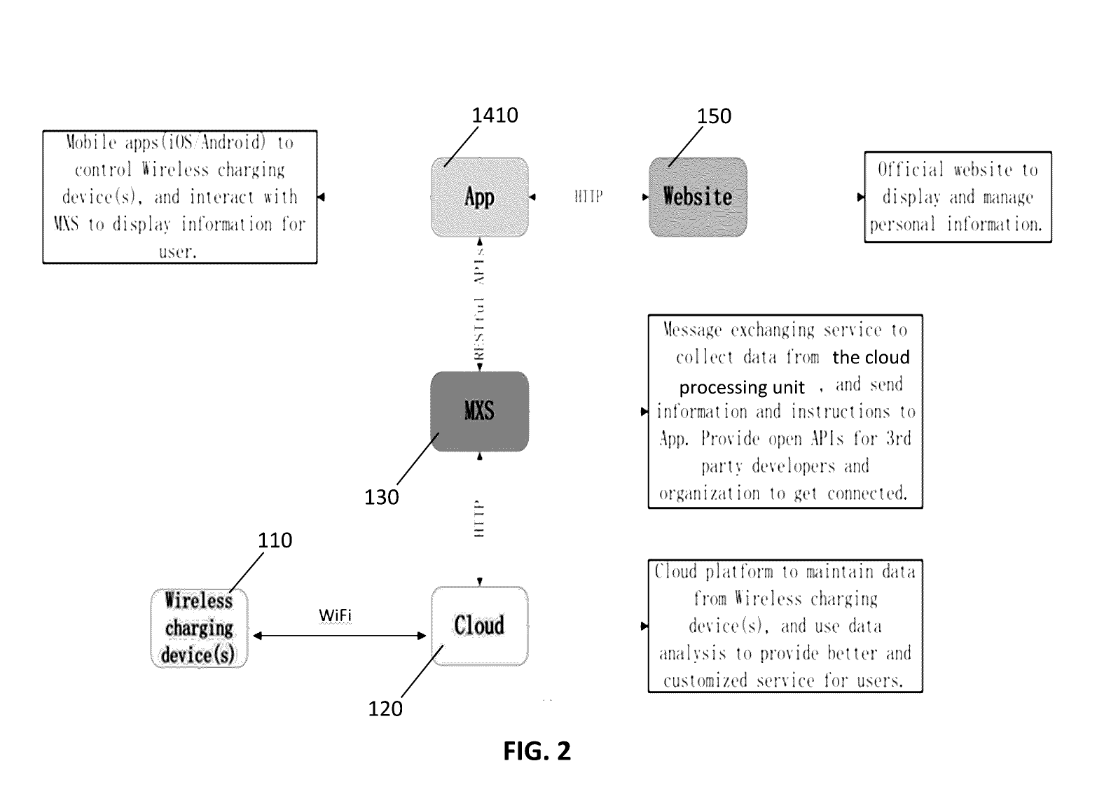

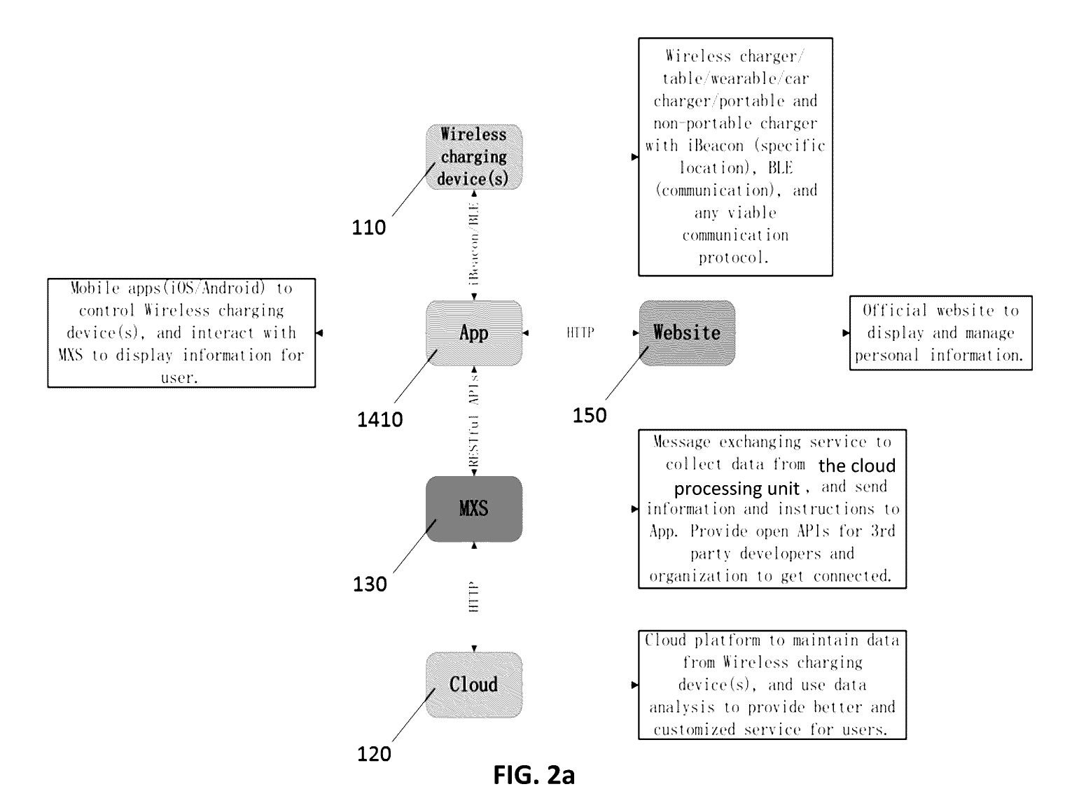

In one aspect, as shown in FIGS. 1 and 2, a location-based message processing system 100 may include one or more internet of things (IoT) devices 110 to 114, a cloud processing unit 120, a message exchanging system (MXS) 130, and one or more mobile terminals 141 to 146. As discussed above, IoT devices can be everyday objects, not just computers and computer networks, which can be readable, recognizable, locatable, addressable, and controllable via an IoT communications network. In an exemplary embodiment, the IoT devices in the present invention are wireless charging devices including but not limited to, wireless chargers, charging tables, wearable charging devices, portable/non-portable chargers.

In one embodiment, the cloud processing unit 120 may include at least a processor and memory device to process, save and maintain data transmitted from the IoT devices (110 to 114), and further analyze the data therefrom through so call “Big Data Processing” to provide better and customized services for the users. The data transmitted from the IoT devices can be, but not limited to the location information of the IoT devices and marketing information including promotions where the IoT devices are located. It is noted that the communication between the IoT devices and the cloud processing unit 120 is WiFi or other viable communication protocol.

In a further embodiment, the message exchanging system (MXS) 130 can be used to receive data from the cloud processing unit 120, and send out information and instruction to the mobile terminals 141 to 146 that may have an application software (“App”) installed therein. The information may include, but not limited to the locations of the IoT devices and promotions at the locations of the IoT devices. The communication between MXS 130 and the App can be achieved by REST (Representational State Transfer) application programming interfaces (“APIs”).

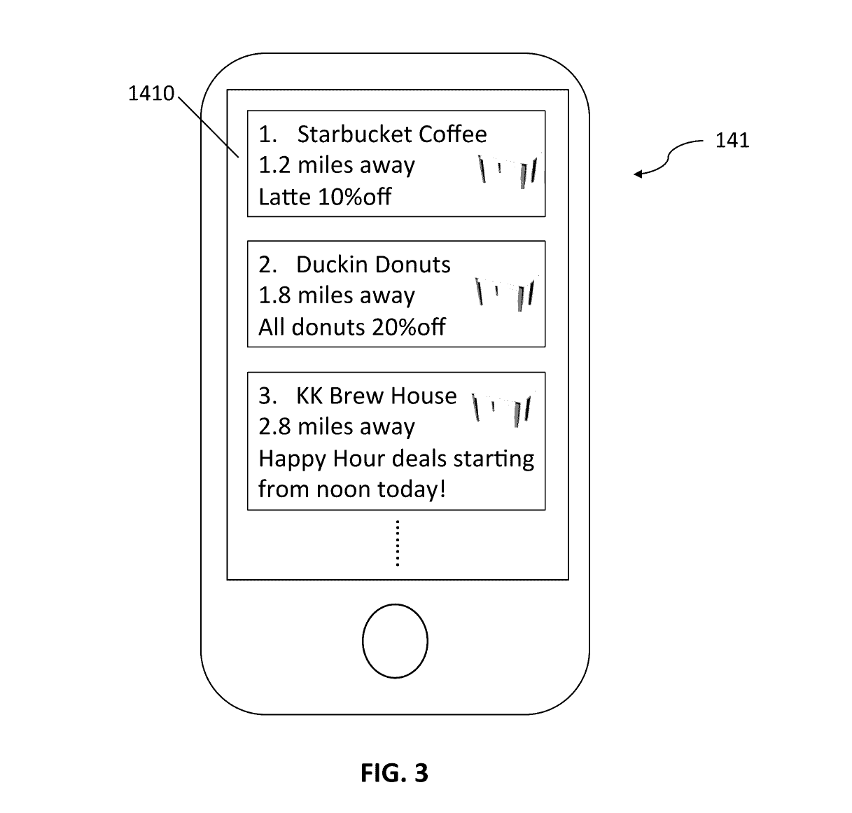

In still a further embodiment, the mobile terminal 141 may be equipped with an App 1410 that can be used to receive specific location-based information from MXS 130, and if the user wishes to receive the information from MXS 130, he/she can just turn on the App 1410. For example, when the user's cell phone battery level becomes low, he/she can turn on the App 1410, which is configured to receive the information from MXS 130 regarding the locations of the wireless charging devices, the distances thereof, and the promotions at which the wireless charging devices are at. As shown in FIG. 3, if the user wishes to charge the cell phone, there are several locations available sorting by the distance with a table sign indicating that there is at least one charging table. In addition, the promotion of each store is included in the information to attract the user.

In another embodiment, the App 1410 can be managed by a website 150, where the user can input and update his/her personal information, and the cloud processing unit 120 can incorporate the user's personal information to generate customized information to the user. For example, if the user does not like to drink coffee, the cloud processing unit 120 can put the information of the coffee shops behind other stores or eliminate it, even if the coffee shop's distance is closest to the user. However, if the user's battery level is very low, the App 1410 may still suggest the user to use the closet point of interest to charge the phone. In a further embodiment, the App 1410 can be managed by the mobile terminal 141.

In another aspect, as shown in FIG. 2a, the IoT devices can directly communicate with the App of the mobile terminal through iBeacon or BLE (Bluetooth Low Energy) communication when the mobile terminal is within a predetermined distance of the IoT devices. For example, when the user is within a predetermined distance from a wireless charging device 110 at a point of interest (e.g. shopping mall, restaurant, coffee shop, etc.), the information of the location of the wireless charging device 110 and the promotion at the wireless charging device 110 will be transmitted directly to the mobile terminal 141 for instance even though the user does not turn on the App 1410. It is noted that the location information of the wireless charging device 110 and the promotion information may also be transmitted to the cloud processing unit 120, so the cloud can save such information, and if the user passes by this location frequently, this factor may be included when the cloud processing unit 120 conducts the big data computing.

In a further aspect, a method for exchanging location-based messages may include steps of: one or more IoT devices transmitting at least location and promotion information to a cloud processing unit 410; the cloud processing unit analyzing the information from the IoT devices and generating customized information for each user 420; a message exchanging system (MXS) receiving the information generated by the cloud processing unit and sending such information to a mobile terminal of the user 430; and the user receiving the information sent from MXS through an application software (“App”), said information at least including the IoT's location and promotion at the IoT's location 440.

In one embodiment, the IoT device can be wireless charging devices including but not limited to, wireless chargers, charging tables, wearable charging devices, portable/non-portable chargers. In another embodiment, the communication between the IoT devices and the cloud processing unit is WiFi or other viable communication protocol. In a further embodiment, the communication between the MXS and the App can be achieved by REST (Representational State Transfer) application programming interfaces (“APIs”). In still a further embodiment, the method for exchanging messages may further include a step of managing the App through the mobile terminal or a website.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A location-based message processing system comprising one or more internet of things (IoT) devices, a cloud processing unit, a message exchanging system (MXS), and one or more mobile terminals, wherein the IoT device is configured to transmitted location-based information to the cloud processing unit, which is configured to save, maintain and analyze the location-based information, and transmit customized information for each user to the MXS, and the MXS is configured to deliver such information to an application software (APP) of the mobile terminal of each user.

2. The location-based message processing system of claim 1, wherein the IoT devices comprise wireless charging devices including wireless chargers, charging tables, wearable charging devices, and portable/non-portable chargers.

3. The location-based message processing system of claim 1, wherein the cloud processing unit comprises at least a processor and memory device to process, save and maintain data transmitted from the IoT devices.

4. The location-based message processing system of claim 1, wherein communication between the MXS and the App includes REST (Representational State Transfer) application programming interfaces (“APIs”).

5. The location-based message processing system of claim 1, wherein the App is managed by a website.

6. The location-based message processing system of claim 1, wherein the App is managed by the mobile terminal.

7. A method for exchanging location-based messages includes steps of:
one or more IoT devices transmitting at least location and promotion information to a cloud processing unit;
the cloud processing unit analyzing the information from the IoT devices and generating customized information for each user;
a message exchanging system (MXS) receiving the information generated by the cloud processing unit and sending such information to a mobile terminal of the user; and
the user receiving the information sent from MXS through an application software (“App”), said information at least including the IoT's location and promotion at the IoT's location.

8. The method for exchanging location-based messages of claim 7, wherein the IoT devices comprise wireless charging devices including wireless chargers, charging tables, wearable charging devices, and portable/non-portable chargers.

9. The method for exchanging location-based messages of claim 7, wherein communication between the IoT devices and the cloud processing unit is WiFi or other viable communication protocol.

10. The method for exchanging location-based messages of claim 7, wherein communication between the MXS and the App is achieved by REST (Representational State Transfer) application programming interfaces (“APIs”).
